(19) United States
(12) Patent Application Publication
(10) Pub. No.: US 2026/0285773 A1
(43) Pub. Date: Sep. 24, 2026

(54) System and Method for Monolithic Fusion

(71) Applicant: IAN ORNSTEIN, TUCSON, AZ (US)

(72) Inventor: IAN ORNSTEIN, TUCSON, AZ (US)

(21) Appl. No.: 19/538,250

(22) Filed: Feb. 12, 2026

(51) Int. Cl. C04B 40/02; C04B 40/00; C04B 103/10

(52) U.S. Cl. CPC C04B 40/02; C04B 40/0021; C04B 2103/10

(57) ABSTRACT

A system and method for inducing non-natural monolithic mineral fusion between discrete mineral-based elements. The system utilizes a Phase-Active Fluid Reagent formulated for pH-triggered hydrolysis and latent activation to reanimate dormant hydration sites within a primary substrate. An Induction Actuator and a Restoration Actuator are operationally synchronized to induce the exudation of mineralized paste immediately prior to material deposition. An Autonomous Control Logic monitors real-time rheology, chemical potential, and environmental energy sources to establish an interfacial crystalline bridge, eliminating discrete cold-joint planes and achieving structural cohesion independent of the hydration state of the mineral elements.

### II. BACKGROUND OF THE INVENTION

Traditional mineral deposition and 3D concrete printing rely on mechanical interlocking or the application of secondary adhesive films. These methods inherently result in “cold-joint” interfaces—planes of weakness that typically exhibit 40-60% less structural integrity than the bulk material. Once a mineral substrate reaches a dormant hydration state, the chemical potential for a monolithic bond is conventionally considered exhausted. The present invention addresses this limitation by providing a system for the active chemical reanimation of dormant sites, facilitating true monolithic fusion across the interface regardless of the age or hydration state of the primary substrate.

### III. BRIEF SUMMARY OF THE INVENTION

The present invention provides a specialized apparatus and chemical process for creating a synthesized mineral matrix between discrete mineral elements. By forcing a non-spontaneous chemical reaction through synchronized mechanical reactivation and chemical modulation, the system establishes a cross-linked crystalline structure. Key technical advancements include active pH-modulation to restart the hydration cycle of cured minerals, autonomous synchronization to ensure mineralized paste is at peak activity during deposition, and the exploitation of kinetic, ultrasonic, and wave-based energy to trigger mineralization.

### IV. BRIEF DESCRIPTION OF THE SEVERAL VIEWS OF THE DRAWINGS

FIG. 1 is a general perspective view of the induction system illustrating the relationship between the actuators and the substrate.

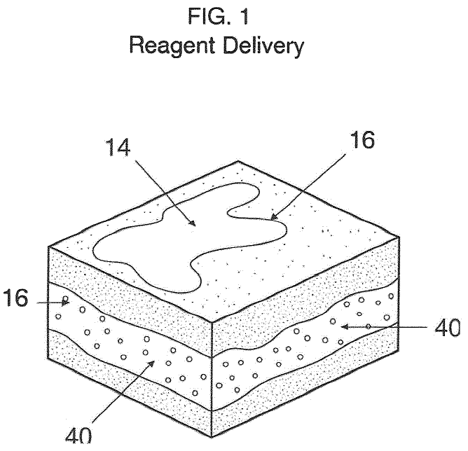

FIG. 2 is a cross-sectional view of the interface transformation zone showing the interstitial crystal growth and the formation of the crystalline bridge.

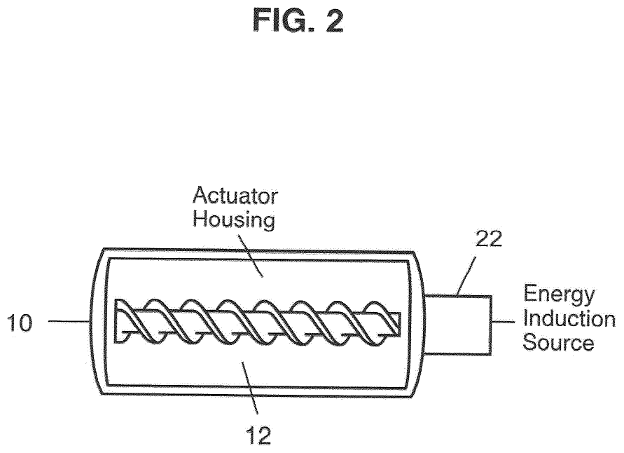

FIG. 3 is a schematic diagram of the autonomous control logic, sensor array, and feedback loops.

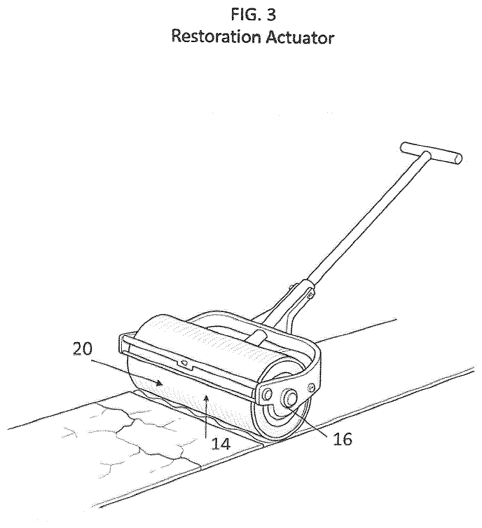

FIG. 4 is a flowchart illustrating the synchronized operational sequence of reanimation and monolithic fusion.

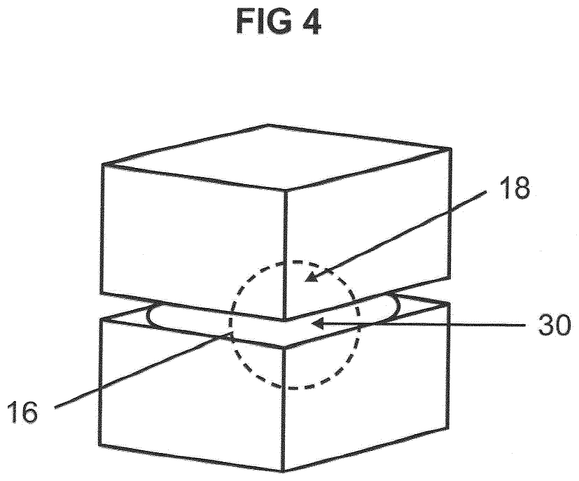

### V. DETAILED DESCRIPTION OF INVENTION

The following detailed description describes the preferred embodiments. Reference numerals correspond to the accompanying drawings. The Reagent and “Chemical CPR” [14] The Phase-Active Fluid Reagent [14] is a chemical formulation provided in liquid, vapor, or aerosol phase. It acts as a “Chemical CPR” by modulating the pH level of the substrate to initiate hydrolysis of dormant mineral phases. This allows for the latent activation of the substrate; the reagent can be pre-incorporated or applied in-situ, remaining dormant until triggered by the system's energy induction. The Restoration and Induction Actuators [10, 12, 20] The Restoration Actuator [20] (e.g., a grinder) is synchronized with material delivery to reactivate the substrate surface. This induces the exudation of mineralized paste—drawing the “cream” of the concrete to the surface. Simultaneously, the Induction Actuator (e.g., a rolling auger) utilizes a controlled pressure differential within a hermetic housing [10] to drive the paste and reagent into the substrate pores. Energy Induction and Autonomous Control [22, 40] The Energy Induction Source [22] delivers localized energy to the transformation zone through various modalities, including kinetic friction, ultrasonic oscillation, or mechanical vibration (e.g., flat plate vibrators). These wave-based energy sources are synchronized with the reagent delivery to accelerate the non-spontaneous phase change and ensure deep interstitial penetration of the mineralized paste. This is managed by the Autonomous Control Logic [40], which monitors sensors (torque, vibration, and chemical potential) to ensure the formation of a monolithic structure.

VI. What is claimed is:

1. A system for inducing non-natural monolithic mineral fusion, comprising a Phase-Active Fluid Reagent [14] formulated for latent activation, an Induction Actuator [10/12], and a Control Interface [40] configured to establish an interfacial crystalline bridge that integrates into the primary substrate.

2. The system of claim 1, wherein a Restoration Actuator [20] is operationally, spatially, or logically synchronized with the induction actuator to provide abrasive reactivation and induce the exudation of mineralized paste within a single continuous operational sequence.

3. The system of claim 1, wherein an Actuator Housing maintains a hermetic or semi-hermetic seal to utilize a controlled pressure differential or modified atmosphere, driving the mineralized paste and reagent into the substrate pores to achieve a synthesized mineral matrix.

4. The system of claim 1, wherein an Energy Induction Source [22] utilizing energy selected from thermal, radiant, wave-based (including ultrasonic and mechanical vibration), kinetic friction, or exothermic chemical heat actively triggers a non-spontaneous phase change at the interface transformation zone.

5. The system of claim 1, wherein the reagent initiates a pH-triggered hydrolysis of dormant mineral phases to induce interstitial crystal growth to a detectable depth within the primary substrate, creating a cross-linked structure independent of the mechanical wear state of the system components.

6. A method of mechanically and chemically reanimating a mineral surface, wherein the reanimation and subsequent fusion are actively induced through the dynamic interplay of a reagent, an induction force, and a controlled atmospheric environment to eliminate discrete cold-joint planes.

7. The system of claim 1, wherein an Autonomous Control Logic varies the induction force, energy, and reagent delivery based on the detected chemical potential, rheology, and porosity of the interface to ensure the formation of a monolithic synthesized structure, independent of the point of origin of the reagent.
